(19) United States
(12) Patent Application Publication
(10) Pub. No.: US 2024/0229744 A1
(43) Pub. Date: Jul. 11, 2024

(54) High Speed Aircraft Propelled by Thorium or Uranium Fueled Molten Salt Reactor

(71) Applicant: Ajay P. Kothari, College Park, MD (US)

(72) Inventor: Ajay P. Kothari, College Park, MD (US)

(21) Appl. No.: 18/403,448

(22) Filed: Jan. 3, 2024

Related U.S. Application Data
(60) Provisional application No. 63/437,184, filed on Jan. 5, 2023.

(51) Int. Cl. F02K 7/10; B64C 30/00; B64D 27/22; F02K 9/42; G21C 3/54; G21D 5/02

(52) U.S. Cl. CPC F02K 7/10; B64D 27/22; F02K 9/42; G21D 5/02; B64C 30/00; G21C 3/54

(57) ABSTRACT

Methods and systems for propelling an air vehicle with a molten salt reactor, a first heat exchanger, and a second heat exchanger are disclosed. A hot liquid molten salt from the molten salt reactor heats a fluid in the first heat exchanger to produce a hot fluid. The hot fluid heats air in the second heat exchanger to produce heated air which passes through a nozzle to propel the air vehicle.

### CROSS-REFERENCE TO RELATED APPLICATIONS

The present application claims priority to U.S. provisional patent application No. 63/437,184.

### BACKGROUND OF THE INVENTION

The Aircraft Nuclear Propulsion (ANP) program and the preceding Nuclear Energy for the Propulsion of Aircraft (NEPA) project worked to develop a nuclear propulsion system for aircraft from 1946 to 1961 when it was cancelled by President Kennedy. However they used solid fueled U235 for energy.

The only US aircraft to carry a nuclear reactor was the NB-36H. The reactor was never actually connected to the engines. The program was canceled in 1958.

In 1957, the Air Force and the U.S. Atomic Energy Commission contracted with the Lawrence Radiation Laboratory to study the feasibility of applying heat from nuclear reactors to ramjet engines. This research became known as Project Pluto. This program was to provide engines for an unmanned cruise missile, called SLAM, for Supersonic Low Altitude Missile. The program succeeded in producing two test engines, which were operated on the ground. On May 14, 1961, the world's first nuclear ramjet engine, “Tory-IIA,” mounted on a railroad car, roared to life for just a few seconds. On Jul. 1, 1964, seven years and six months after it was born, “Project Pluto” was canceled.

### TECHNICAL FIELD

The present invention relates generally to nuclear powered flight. More particularly, the present invention relates to generating and providing the power from nuclear fission in Uranium (U233), which is bred from Thorium (Th232), Molten Salt Reactors (TMSR) to the air vehicle travelling at supersonic or hypersonic speeds.

### SUMMARY

In a first aspect, the disclosure provides an air vehicle thrust system consisting of a molten salt reactor on an air vehicle configured to pass hot liquid molten salt to a first heat exchanger, the first heat exchanger configured to heat a fluid against the hot liquid molten salt to produce a hot fluid and pass the hot fluid to a second heat exchanger, and the second heat exchanger configured to heat air against the hot fluid and pass heated air through a nozzle configured to propel the air vehicle.

In a second aspect, the disclosure provides a method for propelling an air vehicle. An air vehicle is provided with a molten salt reactor, a first heat exchanger, and a second heat exchanger. A hot liquid molten salt is passed to the first heat exchanger from the molten salt reactor. A fluid is heated in the first heat exchanger against the hot liquid molten salt to produce a hot fluid. The hot fluid is passed to the second heat exchanger. Air is heated in the second heat exchanger against the fluid to produce heated air. The heated air is passed through a nozzle to propel the air vehicle.

Further aspects and embodiments are provided in the foregoing drawings, detailed description and claims.

### BRIEF DESCRIPTION OF DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a block diagram showing a method for propelling an air vehicle.

FIG. 2 is a block diagram showing an air vehicle thrust system.

FIG. 3 is a block diagram overlaid on a cross-section of an air vehicle.

FIG. 4 is a block diagram overlaid on a cross-section of the air vehicle of FIG. 3.

FIG. 5 is a top view cross-section of an air vehicle.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “against” in reference to heating in a heat exchanger is meant to refer to the act of passing two different heat exchange fluids through the heat exchanger to induce heat exchange ‘against’ one another. In the embodiments herein, this heat exchange is indirect heat exchange. The heat exchange may be co-current, counter-current, or cross-current.

Generating and providing the power from nuclear fission in Thorium (Th232) or Uranium (U233) Molten Salt Reactor to air vehicles travelling at supersonic or hypersonic speeds, such as a ramjet or a scramjet provides a range and flexibility to air vehicles that is nearly unimaginable. The heat energy of nuclear fission is transferred to a circulating molten salt and further transferred to oncoming air without radioactivity through heat exchangers aft of the inlet, and then expanded through the nozzle to create thrust.

The reactor containment vessel and heat exchangers are made of material such as C/SiC, and hence it would be possible to reach higher temperature up to 1200 C or C/ZrOC with capacity of higher temperatures which, are more advantageous and needed for vehicles travelling at high speeds.

The Aircraft Nuclear Propulsion (ANP) program and the preceding Nuclear Energy for the Propulsion of Aircraft (NEPA) project worked to develop a nuclear propulsion system for aircraft from 1946 to 1961 when it was cancelled by President Kennedy. However they used solid fueled U235 for energy which was an unworkable solution.

The only US aircraft to carry a nuclear reactor was the NB-36H. The reactor was never actually connected to the engines. The program was canceled in 1958.

In 1957, the Air Force and the U.S. Atomic Energy Commission contracted with the Lawrence Radiation Laboratory to study the feasibility of applying heat from nuclear reactors to ramjet engines. This research became known as Project Pluto. This program was to provide engines for an unmanned cruise missile, called SLAM, for Supersonic Low Altitude Missile. The program succeeded in producing two test engines, which were operated on the ground. On May 14, 1961, the world's first nuclear ramjet engine, “Tory-IIA,” mounted on a railroad car, roared to life for just a few seconds. On Jul. 1, 1964, seven years and six months after it was born, “Project Pluto” was canceled.

None of the previous work included Th232 or U233 as fuel or the Molten Salt Reactor concept for energy. No present technology offers a solution to this long-felt need.

Russian attempts at a nuclear-powered air vehicle still produce radioactive exhaust, which is not only dangerous but unsustainable. No passenger air vehicle could be attempted with such a limitation. The present invention overcomes this limitation present in Russian nuclear-powered missiles.

One significant upside to molten salt as a heat exchange liquid for an air vehicle is that molten salt can transfer energy through twisted, intricate, and small channels that would be impossible for air exchange due to volume constraints.

The US needs to operate in anti-access/area denial scenarios for strike and ISR missions. In addition to rocket boosted hypersonic weapons, the US also needs power for long duration hypersonic vehicles and weapons. Chemical propellant power has limited range capability but the present invention will give weapons and platforms almost unlimited range including numerous in atmosphere revolutions. A nuclear powered, highly maneuverable, unlimited range thorium ramjet or similar will serve as a strong war deterrent. This enables extreme range high speed survivable platforms and weapons to prosecute a variety of targets.

The present invention could carry a chemical or even nuclear weapon and can go around the world if wanted. Similar to the Russian Burevestnik but at ram speed. The present invention may be a reusable missile that can deliver a weapon and then return. The present invention would be highly maneuverable and difficult to shoot down just like hypersonic weapons. In one embodiment, the present invention would fly at ˜100K feet.

The molten salt with fissile U233 dissolved in it will drop down to below its freezing point upon a crash. It is solid at those temperatures and the fission stops as thermal neutrons which are slowed down by the graphite moderating rods (energy ˜0.01 ev-100 ev) are not available as the moderator rods are broken as well. The fission capture cross-section for thermal neutrons is ˜531 Barns for U233 but for fission released neutron (˜1-10 MeV) is ˜0.01 to 0.1 Barns. The solidified molten salt rocks are scattered. Thus, the fission stops right away. This is an advantage to using a molten salt reactor as opposed to solid options. Another is that, unlike PWRs which operate at 150-250 atm pressure, molten salt reactors work at or near ambient pressures. So there would not be a pressure related explosion on impact.

Also, U233 has half-life of 159,000 years and emits Alpha radiation. The chunks of rock can be easily picked up as Alpha cannot penetrate even the outer layer of skin.

The energy for the present invention is created through nuclear fission. One of the forces that the physicists have long been trying to amalgamate in the Unified Field Theory is the strong nuclear force, enough to overcome the repellant electrostatic force of protons bound in a nucleus. This binding energy thus residing in nucleus is the boon of nuclear power, in this case the fission power. About 200.1 MeV of energy is released per atom of ⁹²U₂₃₃ upon fissioning. This is a million times greater per unit mass than chemical such as that produced by burning fossil fuel or coal.

A Thorium atom, ⁹⁰Th₂₃₂, when bombarded by a neutron from some external source absorbs that neutron producing ⁹⁰Th₂₃₃, thus increasing the atomic weight by one but not the atomic number. It being unstable, releases one electron via a Beta decay thereby changing its atomic number to one plus viz. Protactinium ⁹¹Pa₂₃₃, more or less instantly, with half-life of 22 mins. ⁹¹Pa₂₃₃ further Beta decays over 27 days to a still higher atomic number viz. ⁹²U₂₃₃ which is fissionable. This atom fissions into Strontium and Xenon atoms, releasing almost the same energy per atom as ⁹²U₂₃₅, viz. 200.1 MeV.

Such energy is harnessed dynamically in the reactor which is carried above the engine (Ramjet or scramjet) through the nuclear reaction in the thorium molten salt reactor. The

molten salt with Th232 or U233 heats up to around 1200 C and circulates in conduits made from appropriate materials, such as C/SiC which can work till about 1250 C, or made from C/ZrOC for even higher temperature. Through a heat exchanger this heat is transferred to another circulating conduit, now with only the molten salt not containing any radioactive material.

An air inlet compresses the oncoming air to the speeds required for subsonic Turbine or supersonic Ram conditions. Downstream of the isolator, the air flows over the secondary heat exchanger pipes. Heat is transferred to the air through convection and conduction to temperatures in the neighborhood of 1200 C or somewhat lower. This heated air is then expanded through the nozzle to create thrust.

The vehicle would take off from CONUS itself, go around the world 2-3 times carrying a payload and land on its own in CONUS either as a glider or under turbine power if it is carrying them also—WITHOUT REFUELING.

Such a vehicle has been sized in simulations. The simulated vehicle may be about 30 ft long and would weigh 10-15K kg. It can be entirely made up of C/SiC, C/ZrOC or a combination of that and some other alloy, especially at Ramjet speeds. The vehicle experiences about 10,000 Newton of drag at Mach 4 which needs to be negated by the thrust produced. This thrust multiplied by cruise velocity yields the power needed which is equal to 26 MW. But taking into account 50% heat energy transfer efficiency, the plant is designed for 53 MW.

Thus the Specific Impulse (ISP=(thrust needed in Newtons)/(MdotF of Thorium expenditure in kg per second)) is of the order of 15 Billion secs.

According to calculations, only about 25 grams of Thorium is needed for one circle around the Earth with this 53 MW plant carried aboard. The amount needed is miniscule compared to the fuel or propellant needed for a vehicle using chemical propulsion which correctly leads to such high ISP as normally defined.

Producing heat energy using Thorium (⁹⁰Th₂₃₂) bred Uranium (⁹²U₂₃₃) dissolved in high temperature salt and using that energy to accelerate oncoming air in a ramjet or scramjet or both is suggested. The word Scramjet is used here to denote the speed regime only as no combustion will take place in the aircraft. The words ramjet and Sramjet (Supersonic Ram) will be used below instead as there is no combustion in the concept below.

The liquid phase character of the fissionable material is very different from previous work done for airplanes almost 60 years ago which either used solid fuel or liquid Uranium 235. This then lends itself very attractively for air vehicles for being able to flow the high temperature materials near the oncoming air in the isolator/combustor areas.

Since no very highly pressurized water is needed as coolant, the size and threat of explosion are reduced substantially with the threat almost nil now. No radioactive air is exhausted as the heat transfer is done as described below.

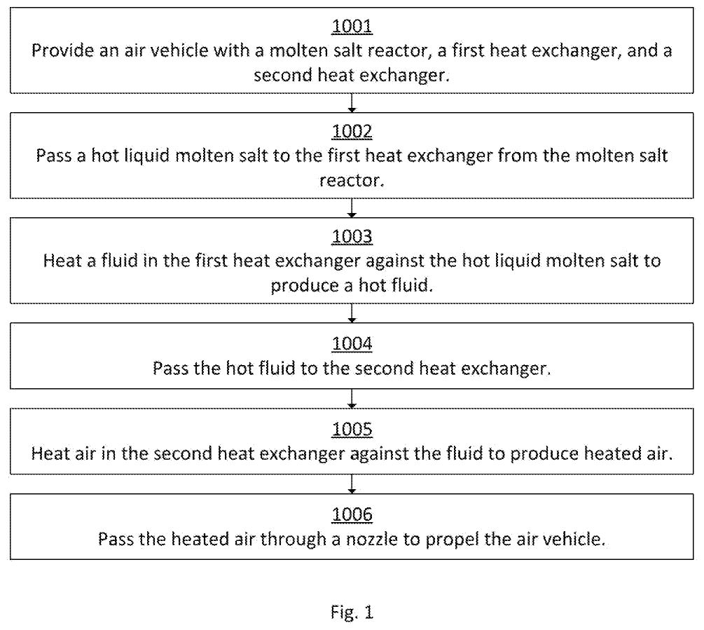

FIG. 1 is a block diagram showing a method for propelling an air vehicle that may be used in one embodiment of the present invention. At 1001, an air vehicle is provided with a molten salt reactor, a first heat exchanger, and a second heat exchanger. At 1002, a hot liquid molten salt is passed to the first heat exchanger from the molten salt reactor. At 1003, a fluid is heated in the first heat exchanger against the hot liquid molten salt to produce a hot fluid. At 1004, the hot fluid is passed to the second heat exchanger. At 1005, air is heated in the second heat exchanger against the fluid to produce heated air.

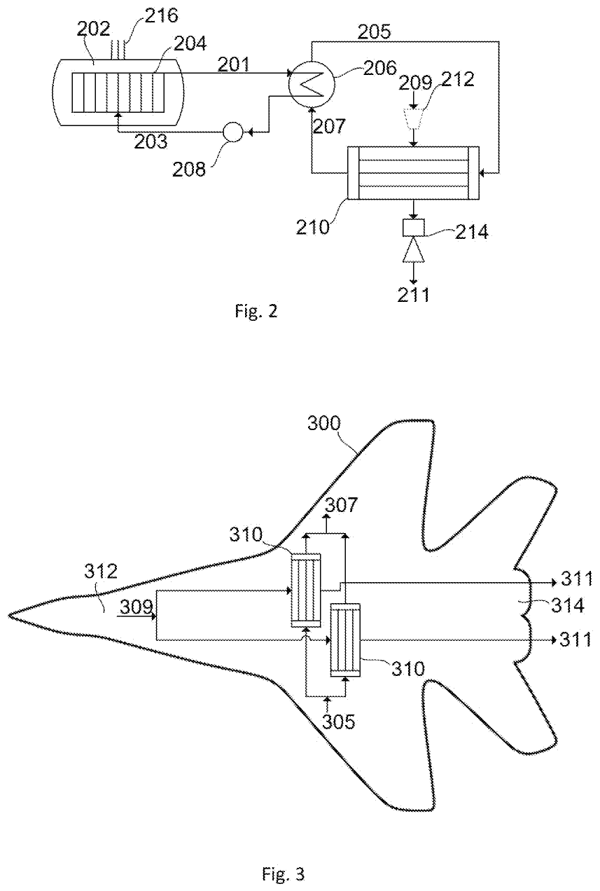

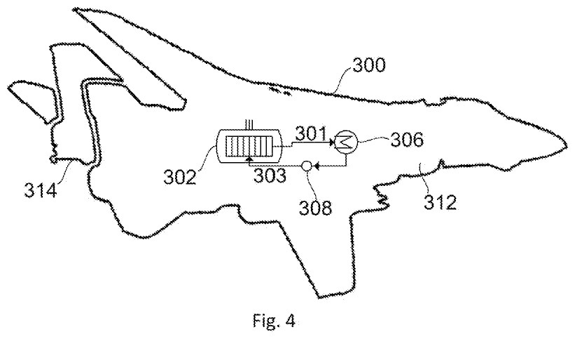

FIG. 2 is a block diagram showing an air vehicle thrust system that may be used in one embodiment of the present invention. All of the equipment shown in FIG. 2 is present on the air vehicle, which is not shown in this figure for clarity. FIGS. 3 and 4 show examples of an air vehicle that the system may be located within. A molten salt reactor 202 with control rods 216 has molten salt coils 204 where molten salt is heated to hot liquid molten salt 201 and passed by pressure from pump 208 through a first heat exchanger 206 and back as liquid molten salt 203 to the molten salt reactor 202. The hot liquid molten salt 201 heats a fluid 207 in the first heat exchanger 206, producing a hot fluid 205. The hot fluid 205 passes through a second heat exchanger 210 against air 209 and is cooled back to the fluid 207. Air 209 from the atmosphere is passed through an air inlet 212 on the air vehicle and into the second heat exchanger 210 where it is heated to hot air 211 by the hot fluid 205. The hot air 211 is passed through a nozzle 214 and ejected from the air vehicle, producing thrust for the air vehicle. In this manner, the molten salt reactor 202 provides heat energy to the air 209 without passing any radiation to the air 209, unlike in some recent attempts at nuclear-powered air vehicles.

FIG. 3 is a block diagram overlaid on a cross-section of an air vehicle that may be used in one embodiment of the present invention. FIG. 4 is a block diagram overlaid on a cross-section of the air vehicle of FIG. 3. FIG. 3 shows the second heat exchangers 310 while FIG. 4 shows the molten salt reactor 302 and the first heat exchanger 306. An air vehicle 300 is provided with an air inlet 312 and nozzles 314. Air 309 enters the air inlet 312 and passes through the second heat exchangers 310, heating the air 309 to hot air 311, which is passed through the nozzles 314 to provide thrust to propel the air vehicle 300. The second heat exchangers 310 are heated by a hot fluid 305 from the first heat exchanger 306, resulting in fluid 307 returning to the first heat exchanger 306. The fluid 307 is heated by hot liquid molten salt 301 in the first heat exchanger 306, resulting in liquid molten salt 303 which passes back to the molten salt reactor 302 for heating.

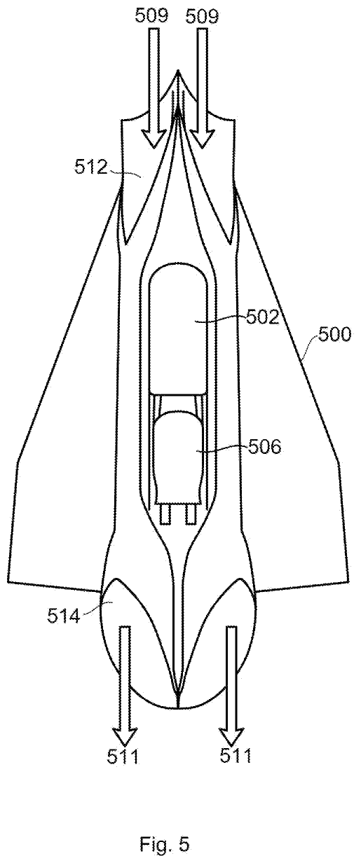

FIG. 5 is a top view cross-section of an air vehicle that may be used in one embodiment of the present invention. A molten salt reactor 502 heats molten salt to hot liquid molten salt and passes it through a first heat exchanger 506 and back as liquid molten salt to the molten salt reactor 502. The hot liquid molten salt heats a fluid in the first heat exchanger 506, producing a hot fluid. The hot fluid passes through a second heat exchanger, not shown, against air 509 and is cooled back to the fluid. Air 509 from the atmosphere is passed through an air inlet 512 on the air vehicle 500 and into the second heat exchanger, where it is heated to hot air 511 by the hot fluid. The hot air 511 is passed through a nozzle 514 and ejected from the air vehicle 500, producing thrust for the air vehicle 500. In this manner, the molten salt reactor 502 provides heat energy to the air 509 without passing any radiation to the air 509, unlike in some recent attempts at nuclear-powered air vehicles.

In one embodiment, the air inlet, the second heat exchanger, and the nozzle together makeup a ramjet, a scramjet, or a turbine or a combination of turbine and ramjet called turbo-ram.

In some embodiments, the molten salt reactor, the first heat exchanger, and the second heat exchanger are made of C/SiC, C/ZrOC, or both. These lightweight materials allow the system to be light enough to fly for a significant amount of time on a minimum of fuel.

In a preferred embodiment, the heated air leaving the nozzle is non-radioactive.

In some embodiments, the fluid is a second liquid molten salt at temperatures above 450 C and below the fluid's boiling temperature.

In some embodiments, the air vehicle flying at supersonic speeds means the air inlet has to compress the oncoming air to subsonic condition so the heat exchange can take place in the second heat exchanger without causing any shocks. This heat exchanger is then able to transfer the heat to this air which goes through a sonic throat to then expand to supersonic conditions using the nozzle to create the necessary thrust.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

1. An air vehicle thrust system comprising:
a molten salt reactor on an air vehicle configured to pass hot liquid molten salt to a first heat exchanger;
the first heat exchanger configured to heat a fluid against the hot liquid molten salt to produce a hot fluid and pass the hot fluid to a second heat exchanger; and
the second heat exchanger configured to heat air against the hot fluid and pass heated air through a nozzle configured to propel the air vehicle.

2. The air vehicle thrust system of claim 1, wherein an air inlet, the second heat exchanger, and the nozzle comprise a ramjet, a scramjet, or a turbine.

3. The air vehicle thrust system of claim 1, wherein the molten salt reactor, the first heat exchanger, and the second heat exchanger are made of C/SiC, C/ZrOC, or both.

4. The air vehicle thrust system of claim 1, wherein the heated air is non-radioactive.

5. The air vehicle thrust system of claim 1, wherein the fluid is a second liquid molten salt at temperatures above 450 C and below the fluid's boiling temperature.

6. A method for propelling an air vehicle comprising:
providing an air vehicle with a molten salt reactor, a first heat exchanger, and a second heat exchanger;
passing a hot liquid molten salt to the first heat exchanger from the molten salt reactor;
heating a fluid in the first heat exchanger against the hot liquid molten salt to produce a hot fluid;
passing the hot fluid to the second heat exchanger;
heating air in the second heat exchanger against the fluid to produce heated air; and
passing the heated air through a nozzle to propel the air vehicle.

7. The method of claim 6, wherein an air inlet, the second heat exchanger, and the nozzle comprise a ramjet, a scramjet, or a turbine.

8. The method of claim 6, wherein the molten salt reactor, the first heat exchanger, and the second heat exchanger are made of C/SiC, C/ZrOC, or both.

9. The method of claim 6, wherein the heated air is non-radioactive.

10. The method of claim 6, wherein the fluid is a second liquid molten salt at temperatures above 450 C and below the fluid's boiling temperature.
